(19) United States
(12) Patent Application Publication
(10) Pub. No.: US 2021/0337904 A1
(43) Pub. Date: Nov. 4, 2021

(54) Sizing garments for manufacturing semi-custom garments

(71) Applicant: Stantt, Inc., New York, NY (US)

(72) Inventors: Matthew HORNBUCKLE, New York, NY (US); Kirk Patrick KEEL, Montclair, NJ (US); Sara Ann BETTS, Greenville, SC (US); Samuel MERRIMAN, Dallas, TX (US)

(21) Appl. No.: 17/374,923

(22) Filed: Jul. 13, 2021

Related U.S. Application Data
(63) Continuation-in-part of application No. 17/230,666, filed on Apr. 14, 2021.
Application No. 17/230,666 is a continuation-in-part of application No. 16/514,283, filed on Jul. 17, 2019.
(60) Provisional application No. 62/851,966, filed on May 23, 2019.

(51) Int. Cl. A41H 1/02; A41D 15/00

(52) U.S. Cl. CPC A41H 1/02; A41D 1/06; A41D 15/00

(57) ABSTRACT

A sizing garment, for a garment of a selected size, has a left part with dimensions for a first fit and a right part with dimensions for a second fit. This sizing garment is applicable to any bifurcated garment. A sizing garment has at least a left part with a first dimension at a first point of measurement, and a right part with a second dimension substantially different from the first dimension at the first point of measurement. A set of sizing garments of different sizes and fits can be manufactured and provided to retailers to assist customers trying on garments before making a purchase. The sizing garment is not intended to be the actual garment selected, purchased, and worn by the individual, but instead is used during the fitting process to allow the individual to see different fits side-by-side as worn. Additional adjustable mechanisms permit further refinement.

### CROSS-REFERENCE TO RELATED APPLICATIONS

This application is a continuation-in-part of U.S. patent application Ser. No. 17/230,666, filed Apr. 14, 2021, entitled “Sizing Garment with Left and Right Parts of Different Fits”, which is a continuation-in-part of U.S. patent application Ser. No. 16/514,283, filed Jul. 17, 2019, entitled “Sizing Garment with Left and Right Parts of Different Fits”, which is a non-provisional patent application of U.S. Provisional Patent Application Ser. No. 62/851,966, filed May 23, 2019, entitled “Sizing Pants with Legs of Different Fits”, which are hereby incorporated by reference.

### BACKGROUND

When an individual purchases a garment, there are several factors that affect the size of the garment which the individual selects. Dimensions at certain points of measurement related to length, if sized incorrectly, make a garment appear too long or too short, such as the length of shirt sleeves and pant legs. Dimensions at other points of measurement related to circumference, if sized incorrectly, make a garment appear too big or too small, such as the waist on pants or neck on a shirt. Dimensions at yet other points of measurement relate to fit, where, even if the garment is otherwise sized correctly, affect how tight or loose the garment appears. However, personal preference and style often plays a significant role in the selection of the right fit of a garment. Often, garment manufacturers make garments with different fits. Thus, a garment of a selected size may be available in multiple fits. For example, pants of a given size may be available in multiple fits, such as a loose fit, a relaxed fit, or a tighter fit.

### SUMMARY

This Summary introduces a selection of concepts in simplified form that are described further below in the Detailed Description. This Summary neither identifies key or essential features, nor limits the scope, of the claimed subject matter.

Individuals generally try on different garments of different sizes and fits to select a garment with the best size and fit. An individual may try on different garments to find the right size, and then try on different garments of the same size but with different fits. An individual may try on garments of a variety of combinations of sizes and fits. This process can be tedious and can take a substantial amount of time.

A garment size can be selected from among garments designed and manufactured according to a size grid that provides custom-like fit for ready-to-wear garments. The size grid is generated by a data mining process performed on based on data from many individuals. The data mining process identifies, groups, subgroups, and sub subgroups of anchor measures and priority measures. Such a size grid for a garment (e.g., shirt, pants) for a group of individuals, (e.g., men, women, children) includes a large number of sizes, anywhere from a few dozen to over two hundred. Patterns are generated for the garment for each size in the size grid, from which the garment in any selected size can be manufactured. Using such a system, given dimensions of an individual at certain points of measurement, these dimensions can be screened against the groups, subgroups, and sub subgroups of anchor measures and priority measures to determine a correct size from the size grid that is close to the dimensions of the individual. Size grids for any kind of garment can be created using such an analysis.

As an example, a computer system can generate a size grid for pants based on groups, subgroups, and sub subgroups of anchor measures and priority measures derived from data from many individuals. Patterns for pants can be generated, and such pants can be manufactured, according to this size grid. In such a size grid, each size specifies dimensions for a set of points of measurement for pants. Such points of measurement for pants can include, but are not limited to, for example, waist, waist top of band, hip, hip offset from bottom of fly, thigh at crotch, knee, knee at one-half of inseam, ankle, front rise to top of waistband, back rise to top of waistband, fly zipper, inseam, and waistband width. Some points of measurement are more indicative of a type of fit. In the case of pants, points of measurement related to the knee and ankle, for example, generally define fit.

Dimensions at selected points of measurement on an individual can be taken and mapped to a size in the size grid. Individual dimensions that can be used to select a size for pants can include, but are not limited to, for example, waist, seat, and rise. The length (whether measured as an inseam or an outseam) of a leg can be an input individual dimension, or can be measured after mapping waist, seat, and rise dimensions to a garment size. Given dimensions for the pants at points of measurement such as the waist, seat, and rise, and a length, for pants, fit of the pants is determined in large part by dimensions at the knee and ankle. As another example, for shirts, dimensions for a shirt at points of measurement such as a wrist, upper arm, or forearm, typically affect fit of the shirt.

Given a size for a garment, to assist an individual in comparing and selecting from garments of different fits, a sizing garment is provided. For a garment of a selected size, the sizing garment has a left part with dimensions for a first fit, and a right part with dimensions for a second fit. The sizing garment may include one or more points of measurement along which the dimension for the garment is adjustable, such as the length of a pant leg, or the length of a sleeve of a shirt or a blazer, or a length of a front or tail of a shirt or blazer. Indicia of dimension, such as a measuring tape, may be affixed along that point of measurement, such as along the inseam of a pant leg, or a seam along a sleeve of a shirt or blazer. The sizing garment may include additional a mechanically adjustable part, such as a zipper, one or more snaps, hook and loop connector, or other adjustable mechanism, which has a plurality of possible positions. The adjustable part provides different fits when placed in the different positions.

This sizing garment is applicable to any bifurcated garment (i.e., a garment divided into a left part and a right part, where left and right are defined with respect to the individual wearing the garment). A bifurcated garment is intended to be generally symmetrical with respect to certain dimensions related to size and fit. As used herein, a bifurcated garment is intended to mean any garment that has a left part and a right part, regardless of the section of the body on which it is worn and regardless of any gender or age category associated with the style of garment, including but not limited to shirts, jackets, pants, bloomers, jumpsuits, pantsuits, trousers, jeans, and other garments. The sizing garment is not intended to be the actual garment selected, purchased, and worn by the individual, but instead is used during the fitting process to allow the individual to see different fits side-by-side as worn.

Accordingly, a sizing garment has at least a left part with a first dimension at a first point of measurement, and a right part with a second dimension substantially different from the first dimension at the first point of measurement. For example, sizing pants for a given size has pant legs with different dimensions at points of measurement related to fit to allow visual side-by-side comparison of the two fits in the same size in one garment.

The sizing garment can have at least one adjustable mechanism along at least a third dimension of the sizing garment. The garment to be selected is based on a selection between the first fit and the second fit and a point of measurement along the third dimension based on the at least one adjustable mechanism. In some implementations, the adjustable mechanism can include indicia corresponding to points of measurement along the third dimension, wherein the garment to be selected is based on a selection between the first fit and the second fit and a selected point of measurement along the third dimension. In some implementations, the adjustable mechanism can include a mechanically adjustable part having a plurality of possible positions along the third dimension, wherein the garment to be selected is based on a selection between the first fit and the second fit and a selected position of the mechanically adjustable part along the third dimension. In some implementations, the at least one adjustable mechanism can include both indicia corresponding to points of measurement along the third dimension and a mechanically adjustable part having a plurality of possible positions along a fourth dimension, such that the garment to be selected is based on a selection between the first fit and the second fit, a selected point of measurement along the third dimension, and a selected position of the mechanically adjustable part along the fourth dimension. Multiple additional adjustable mechanisms can be provided along yet additional dimensions of the sizing garment.

For example, pants of a first size and a first fit may have a first knee dimension of 15.5 inches and a first ankle dimension of 14.125 inches. Pants of the same first size, but of a different second fit, may have a second knee dimension of 13.5 inches and a second ankle dimension of 12.625 inches. The dimensions at points of measurement defined by the size may be the same on both pants. The sizing pants for the same first size has a first pant leg with the first knee dimension and the first ankle dimension, and a second pant leg with the second knee dimension and the second ankle dimension, thus having pant legs with different fits. The pants of the first and second fits, and sizing pants, all the same size, have certain dimensions in common related to the size, and vary with respect to other dimensions related to fit. Such a sizing garment allows a visual side-by-side comparison of the two fits in the same size in one garment.

Given a sizing grid for a garment, which has associated points of measurement defining size, and different definitions of fit for the garment, which have associated points of measurement associated with fit, patterns are generated for manufacturing the garment in selected sizes in the size grid, and for different fits within those sizes. Patterns are also generated for manufacturing sizing garments in different sizes of the size grid. Patterns can be semi-custom generated for an individual using the pattern for a selected size and selected fit, and modifying that pattern based on using the settings of the adjustable mechanisms on the sizing garment for that individual. Thus, the selected length of an inseam, sleeve, shirt or blazer front, or shirt or blazer tail can be used to generate a semi-custom pattern for that individual. The selected position of other adjustable mechanisms, such as a zipper, snap, or other part, also can be used to further modify that pattern. Since the range of possible positions is known in advance and limited, the corresponding semi-custom patterns can be generated in advance.

A set of sizing garments of different sizes and fits can be manufactured and provided to retailers to assist customers selecting garments before making a purchase. The set of sizing garments also can be part of a collection of garments in different sizes and fits. For each size, the set of sizing garments includes a plurality of sizing garments for that size. For example, a first sizing garment for the size has a first left part with a first dimension for a first fit in the size, and a first right part with a second dimension for a second fit in the size. A second sizing garment for the size has a second left part with the first dimension for the first fit in the size and a second right part with a third dimension for a third fit in the size. The first, second, and third fits, and respective dimensions, are different from each other.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

FIG. 1 is a front plan view of sizing pants.

FIG. 2 is a back plan view of sizing pants.

FIG. 3 is a side plan view of sizing pants.

FIG. 4 is an illustration of a pattern for right and left backs of sizing pants.

FIGS. 5A and 5B are an illustrative example of a pattern with example dimensions for sizing pants.

FIG. 6 is a block diagram of a general-purpose computer.

FIGS. 7A and 7B illustrate an adjustable mechanism on the back of pants.

FIGS. 8A and 8B illustrate an adjustable mechanism on one side of pants.

FIG. 9 illustrates a measurement tape on an inseam of pants.

FIGS. 10A and 10B illustrate an adjustable mechanism on one side of a shirt.

FIGS. 11A and 11B illustrate measurement tapes on a shirt.

FIGS. 12A and 12B illustrate an adjustable mechanism on one side of a blazer.

FIGS. 13 and 14 illustrate measurement tapes on a blazer.

FIGS. 15A through 15D illustrate an adjustable mechanism on one side of a blazer.

FIG. 16 is a data flow diagram of a system for manufacturing a semi-custom garment.

### DETAILED DESCRIPTION

As described herein, a sizing garment, for a garment of a selected size, has a left part with dimensions for a first fit and a right part with dimensions for a second fit. This sizing garment is applicable to any bifurcated garment (i.e., a garment divided into a left part and a right part, where left and right are defined with respect to the individual wearing the garment). A bifurcated garment is intended to be generally symmetrical with respect to certain dimensions related to size and fit. As used herein, a bifurcated garment is intended to mean any garment that has a left part and a right part, regardless of the section of the body on which it is worn and regardless of any gender or age category associated with the style of garment, including but not limited to shirts, jackets, pants, bloomers, jumpsuits, pantsuits, trousers, jeans, and other garments. The sizing garment is not intended to be the actual garment selected, purchased, and worn by the individual, but instead is used during the fitting process to allow the individual to see different fits side-by-side as worn. The following description provides an example of sizing pants as a kind of sizing garment.

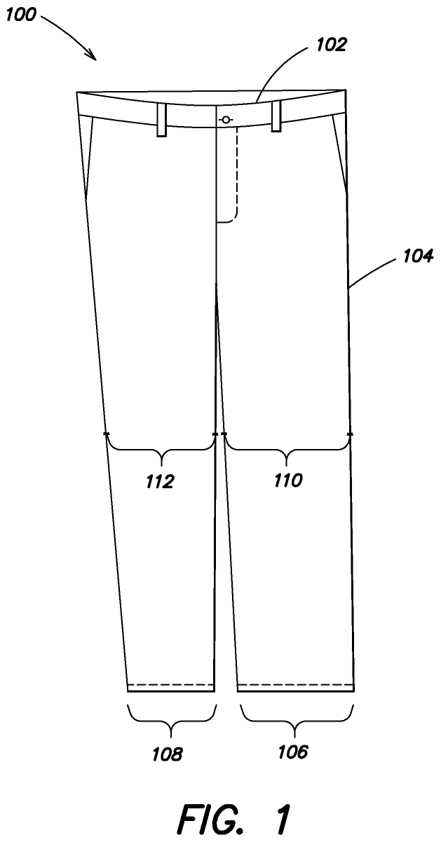

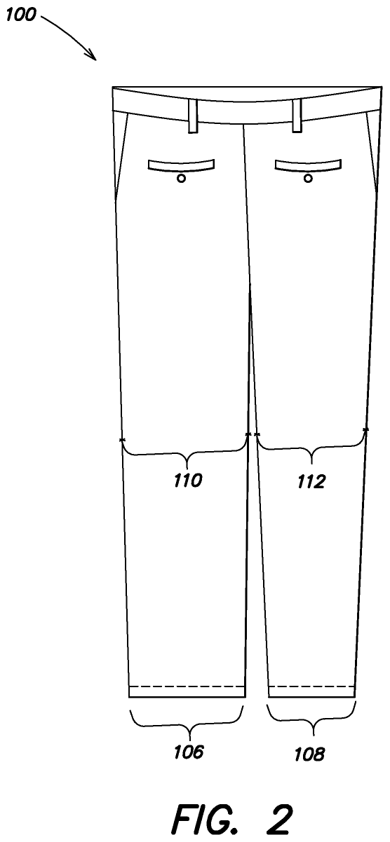

FIG. 1 is a front plan view of an example of sizing pants. The sizing pants 100 have a waistband 102 and an outseam 104 along the outer length of a pant leg of the pants. Dimensions at these and/or other points of measurement may define a size for the pants 100, whereas dimensions at one or more other points of measurement may define a fit for that size of pants. As an example, pants of a first size and a first fit may have a first knee dimension of 15.5 inches and a first ankle dimension of 14.125 inches. Pants of the same first size, but of a different second fit, may have a second knee dimension of 13.5 inches and a second ankle dimension of 12.625 inches. The dimensions at points of measurement defined by the size may be the same on both pants. Sizing pants 100 for the same first size have a first pant leg with the first knee dimension 110 and the first ankle dimension 106, and a second pant leg with the second knee dimension 112 and the second ankle dimension 108, thus having pant legs with different fits. Pants having the first fit, pants having the second fit, and sizing pants, all for the same size, have certain dimensions in common related to the size, and vary with respect to the other dimensions related to fit. Such a sizing garment allows a visual side-by-side comparison of the two fits in the same size in one garment. FIG. 2 is a back plan view of the sizing pants of FIG. 1.

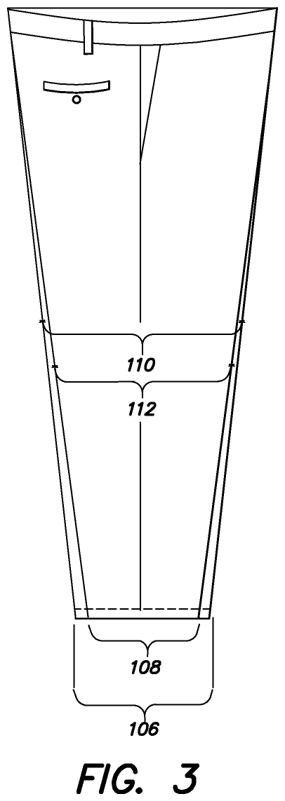

FIG. 3 is a side plan view of the sizing pants of FIGS. 1 and 2. As FIG. 3 illustrates, there is a substantial difference between the first knee dimension 110 and the second knee dimension 112, and between the first ankle dimension 106 and the second ankle dimension 108. The size difference is based on fit as designed into the pattern to make the pants, not differences due to manufacturing error and variations, such as cutting error, shrinkage, stretching, and other variations due to materials, type of garment, and handling. The size differences based on fit generally are outside of the range of such typical manufacturing variances. Generally, manufacturing tolerances for clothing, depending on the garment, type of material, and manufacturing techniques, are less than 0.25 inch (6.35 mm), and in worst cases at most about 0.5 inch (12.7 mm). Differences in dimensions due to fit, referred to herein as “substantial differences”, typically exceed manufacturing variances, and thus generally are greater than 0.5 inch (12.7 mm), and typically are in the range of 0.75 inches (19.05 mm) to 2.75 inches (69.85 mm).

Accordingly, a sizing garment has at least a left part with a first dimension at a first point of measurement, and a right part with a second dimension substantially different from the first dimension at the first point of measurement. For example, sizing pants for a given size has pant legs with different dimensions at points of measurement related to fit to allow visual side-by-side comparison of the two fits in the same size in one garment.

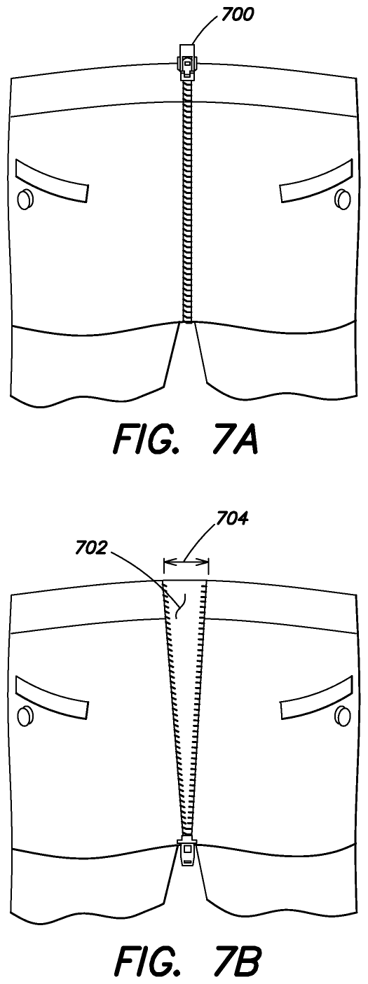

As will be further described in connection with FIGS. 7A-7B through FIG. 14, such a sizing garment also can have one or more adjustable mechanisms that provide further information along one or more additional dimensions that affect the fit of the garment for an individual.

As an example, sizing pants or other sizing garment may include one or more points of measurement along which the dimension for the garment is adjustable, such as the length of a pant leg or of a sleeve, front, or tail of a shirt or jacket, and indicia of dimension, such as a measurement tape, may be available along that point of measurement, such as along the inseam of a pant leg, or seam of a sleeve, or front or tail of a shirt or jacket. Examples of such structures are shown in U.S. Pat. No. 4,200,938, U.S. Patent Publication 2008/0072360, and/or U.S. Patent Publication 2007/0083969, hereby incorporated by reference.

The sizing garment can have at least one adjustable mechanism along at least a third dimension of the sizing garment. The garment to be selected is based on a selection between the first fit and the second fit and a point of measurement along the third dimension based on the at least one adjustable mechanism. In some implementations, the adjustable mechanism can include indicia corresponding to points of measurement along the third dimension, wherein the garment to be selected is based on a selection between the first fit and the second fit and a selected point of measurement along the third dimension. In some implementations, the adjustable mechanism can include a mechanically adjustable part having a plurality of possible positions along the third dimension, wherein the garment to be selected is based on a selection between the first fit and the second fit and a selected position of the mechanically adjustable part along the third dimension. In some implementations, the at least one adjustable mechanism can include both indicia corresponding to points of measurement along the third dimension and a mechanically adjustable part having a plurality of possible positions along a fourth dimension, such that the garment to be selected is based on a selection between the first fit and the second fit, a selected point of measurement along the third dimension, and a selected position of the mechanically adjustable part along the fourth dimension. Multiple additional adjustable mechanisms can be provided along yet additional dimensions of the sizing garment.

FIGS. 7A and 7B illustrate an adjustable mechanism on the back of pants. In this implementation, the adjustable mechanism is in the form of a zipper 700 which can be open (FIG. 7B) or closed (FIG. 7A). A piece of material 702 is behind the zipper, with a width 704. When the zipper is open, the waistband of the pants expands the width of the material 702. An example width that may be used is about one (1) inch (2.54 cm), but any size within a range of about one-half inch to one inch can be useful.

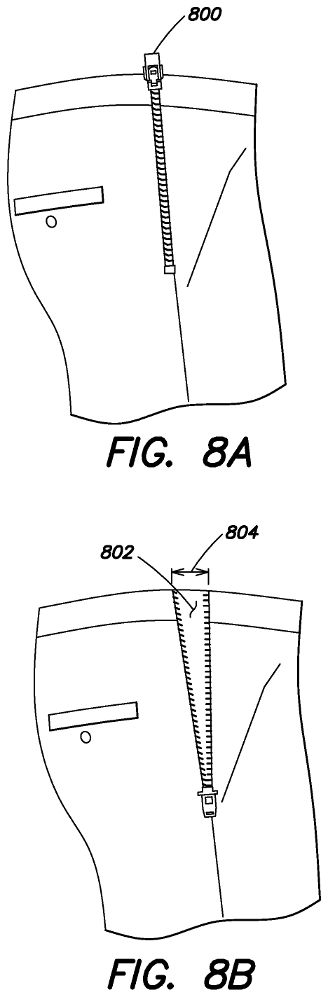

FIGS. 8A and 8B illustrate an adjustable mechanism on one side of the pants. Another similar adjustable mechanism typically would be provided on the other side of the pants. In this implementation, the adjustable mechanism is in the form of a zipper 800 which can be open (FIG. 8B) or closed (FIG. 8A). A piece of material 802 is behind the zipper, with a width 804. When the zipper is open, the waistband of the pants expands the width of the material 802. An example width that may be used is about one-half inch, but any size within a range of about one-half inch to one inch can be useful. Typically, one would adjust this mechanism in the same way on both sides of the pants (either both open or both closed).

In combination, if the dimension 704 is one inch and 804 (each side) is about one-half inch, when used in combinations, these mechanisms allow for expansion of the waistband by 1 inch (back only open), 1 inch (both sides open and back closed), or 2 inches (back and sides all open).

Note that the embodiments shown in FIGS. 7A-7B and 8A-8B are merely illustrative, and other mechanisms besides a zipper, and a variety of dimensions, and any number of such mechanisms, can be used to provide expansion of the waistband.

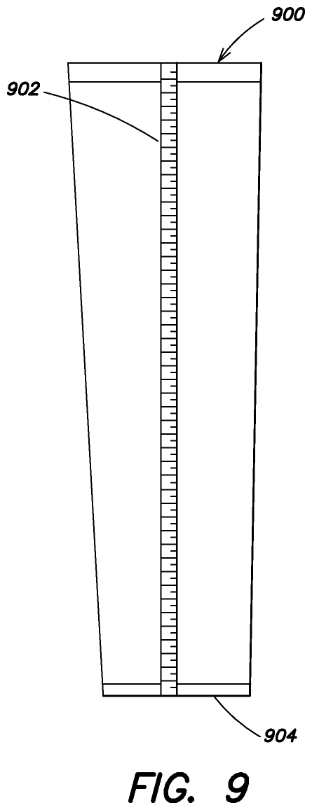

In FIG. 9, an embodiment of the sizing pants can be adjustable along the length of the pant leg 900. This embodiment can be used in combination with or separately from the adjustable mechanisms for the waistband for which examples are shown in FIGS. 7A-7B and 8A-8B. Indicia of dimension, such as a measurement tape 902, may be available along the inseam of the pant leg. The length of the pant leg can be adjusted at the bottom 904 and the measurement indicated by the measurement tape 902 at the adjusted length become the length of the pant leg in the garment to be purchased. Note that because the measurement tape 902 is integrated into the sizing garment, which is made from the same pattern used to make the garment to be manufactured, the length measurement more accurately corresponds to the actual length for the garment to be manufactured.

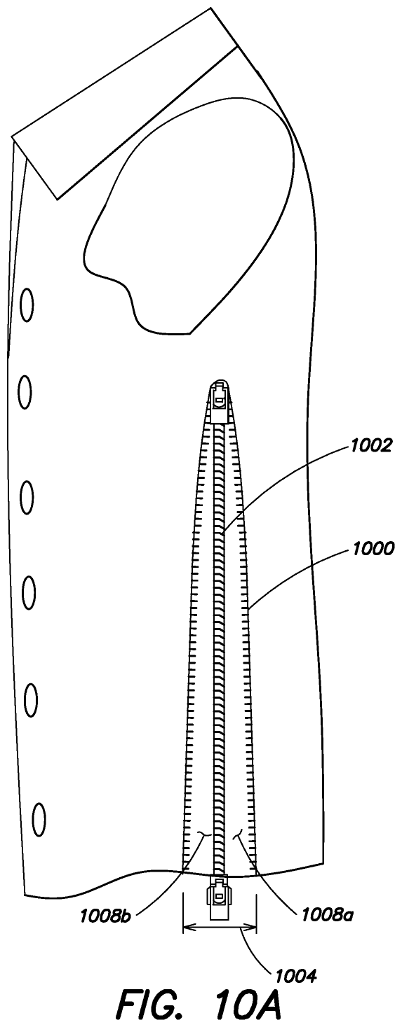

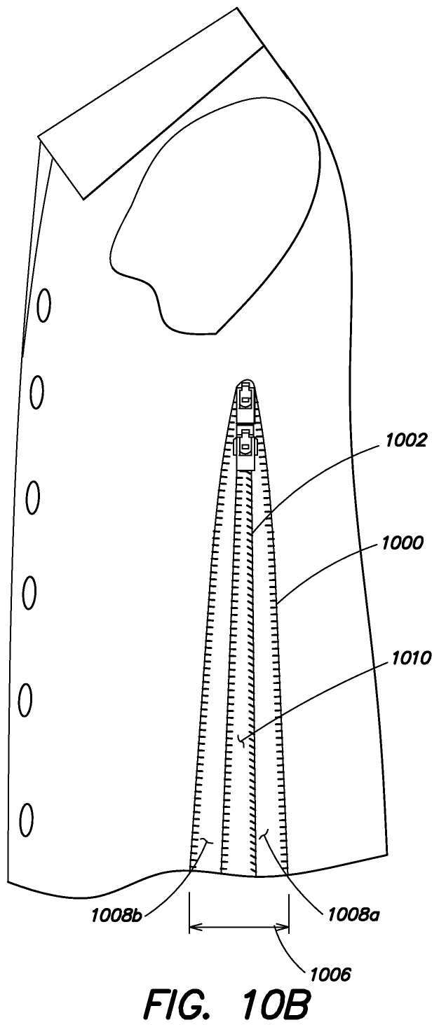

FIGS. 10A and 10B illustrate an adjustable mechanism on one side of a shirt. Another similar adjustable mechanism typically would be provided on the other side of the shirt. In this implementation, the adjustable mechanism is in the form of two zippers 1000 and 1002. Zipper 1000 can be open (FIGS. 10A and 10B) or closed (not shown). After zipper 1000 is open, zipper 1002 can be open (FIG. 10B) or closed (FIG. 10A). Two pieces of material 1008a, 1008b are behind zipper 1000, on either side of zipper 1002, such that when zipper 1000 is open and zipper 1002 is closed, the side of the shirt is expanded by a width 1004 of about the combined widths of materials 1008a, 1008b, and zipper 1002. A piece of material 1010 is behind zipper 1002. When the zipper 1002 is open, the side of the shirt is expanded by a width 1006 of about the combined widths of materials 1008a, 1008b, and 1010. An example width that may be used to expand the shirt for each zipper is about one inch, but any size within a range of about one-half inch to one inch can be useful. Typically, one would adjust this mechanism in the same way on both sides of the shirt.

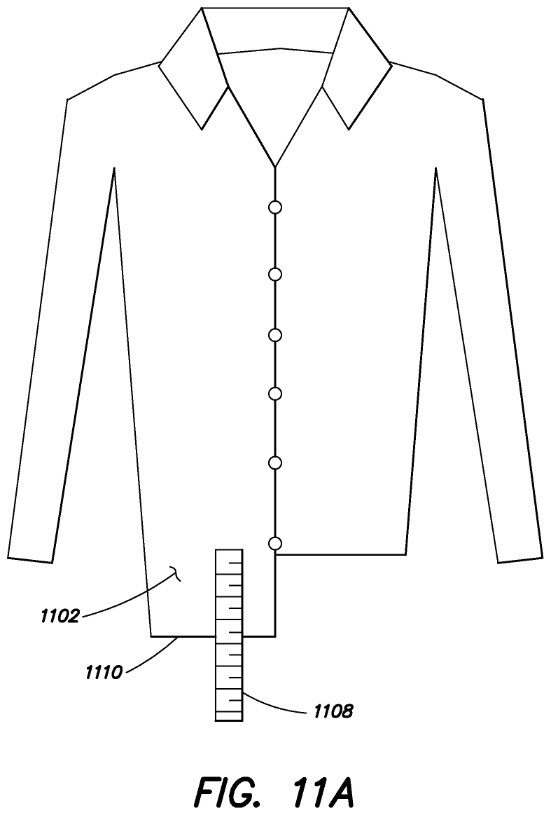

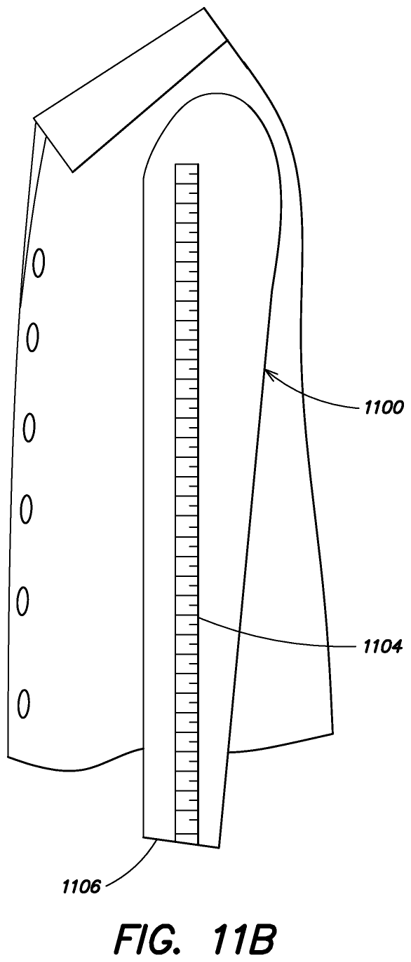

In FIGS. 11A and 11B, an embodiment of a sizing shirt can be adjustable along the length of the sleeve 1100 (FIG. 11B) or along the length of the front 1102 (FIG. 11A) or along the length of the back (not shown), or any combination of these. This embodiment can be used in combination with or separately from the adjustable mechanisms for the side of the shirt, for which examples are shown in FIGS. 10A-10C. Indicia of dimension, such as a measurement tape 1104 (FIG. 11B) may be provided along the outside of the sleeve. The length of the sleeve can be adjusted at the bottom 1106 and the measurement indicated by the measurement tape 1104 at the adjusted length become the length of the sleeve in the garment to be purchased. Indicia of dimension, such as a measurement tape 1108 (FIG. 11A) may be provided along the length of the bottom of the front of the shirt. The length of the front of the shirt can be adjusted at its bottom 1110 and the measurement indicated by the measurement tape 1108 at the adjusted length become the length of the front of the shirt in the garment to be purchased. Note that because the measurement tapes 1104 and 1108 are integrated into the sizing garment, which is made from the same pattern used to make the garment to be manufactured, the length measurement more accurately corresponds to the actual length for the garment to be manufactured.

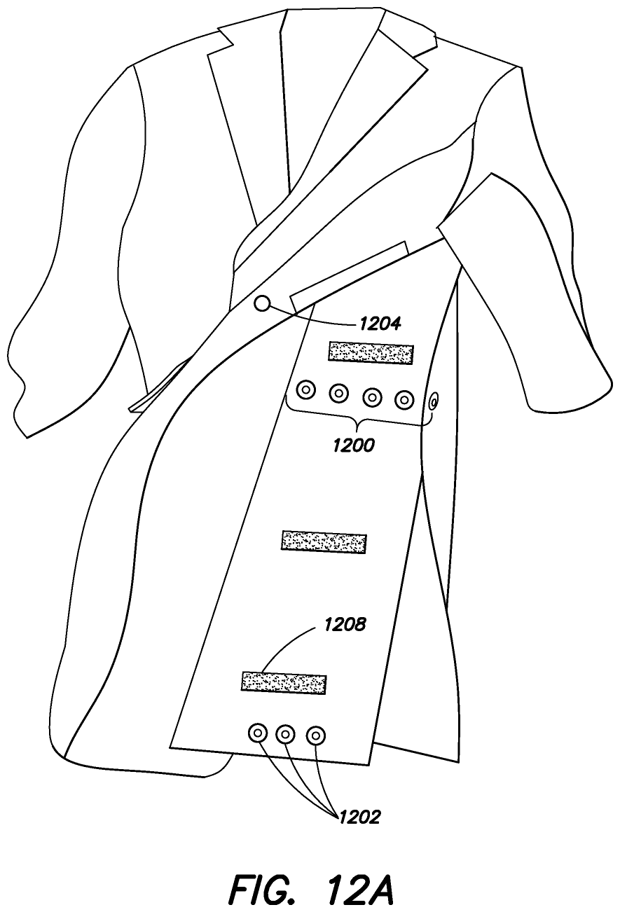

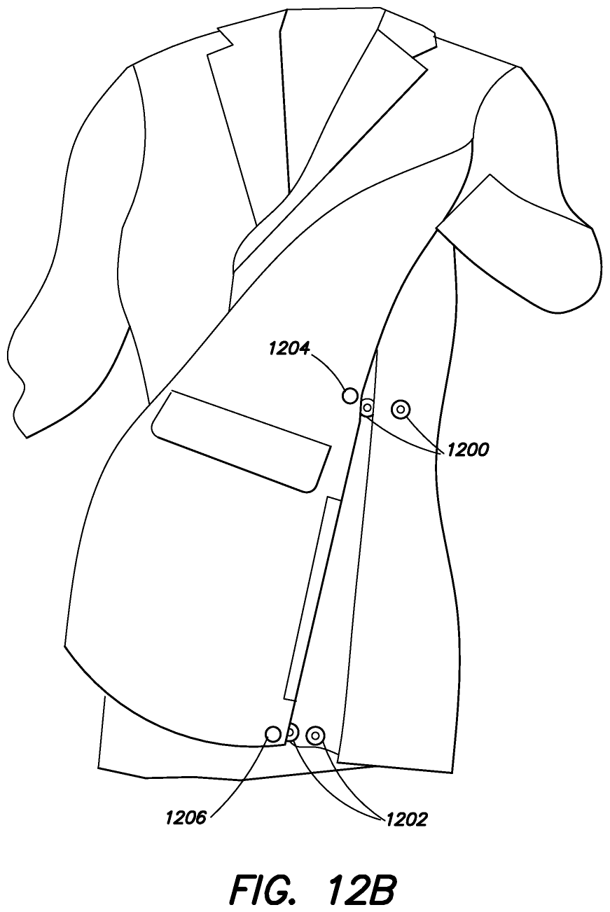

FIGS. 12A and 12B illustrate an adjustable mechanism on one side of a blazer. Another similar adjustable mechanism typically would be provided on the other side of the blazer. In this implementation, the adjustable mechanism is in the form of two sets of snaps 1200 and 1202, and their mating pieces, such as 1204 and 1206 (FIG. 12B), respectively. Snap piece 1204 can mate with any of the pieces in the set 1200, which are all shown as open in FIG. 12A. Similarly, snap piece 1206 can mate with any of the pieces in the set 1202, which also are all shown as open in FIG. 12A. The snaps in each set typically would be evenly spaced apart, but the spacing may be different in the different sets. The spacing of the snaps in the top set can be, for example, about one inch, but any size with a range of about one-half inch to one inch can be useful. The spacing of the snaps in the bottom set can be, for example, about one-half inch. One or more hook and loop closures, or other material, such as shown at 1208, can help hold the fabric of the parts of the blazer together after the snaps are in place to better judge the fit of the blazer. In FIG. 12B, each snap 1204 and 1206 is shown connected to the third (from the back) mating snap piece. Typically, one would adjust this mechanism in the same way on both sides of the blazer.

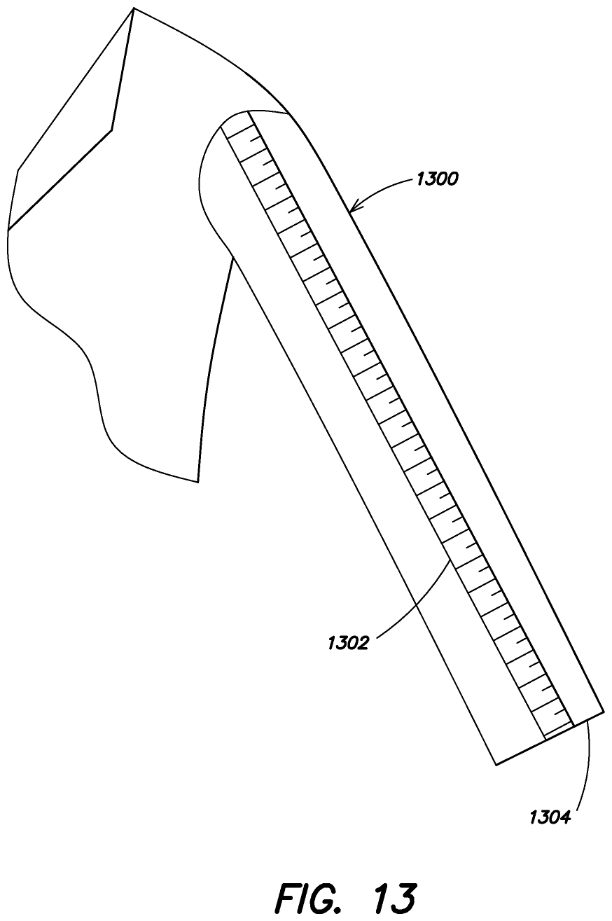

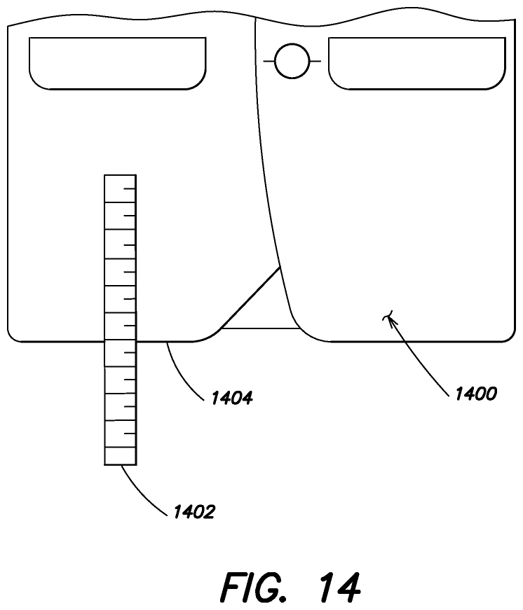

In FIGS. 13 and 14, an embodiment of a sizing blazer can be adjustable along the length of the sleeve 1300 (FIG. 13) or along the length of the front 1400 (FIG. 14) or along the length of the back (not shown), or any combination of these. This embodiment can be used in combination with or separately from the adjustable mechanisms for the side of the blazer, for which examples are shown in FIGS. 12A-12B. Indicia of dimension, such as a measurement tape 1302 (FIG. 13) may be provided along the outside of the sleeve. The length of the sleeve can be adjusted at the bottom 1304 and the measurement indicated by the measurement tape 1302 at the adjusted length become the length of the sleeve in the garment to be purchased. Indicia of dimension, such as a measurement tape 1402 (FIG. 14) may be provided along the length of the bottom of the front of the blazer. The length of the front of the blazer can be adjusted at its bottom 1404 and the measurement indicated by the measurement tape 1402 at the adjusted length become the length of the front of the blazer in the garment to be purchased. Note that because the measurement tapes 1302 and 1402 are integrated into the sizing garment, which is made from the same pattern used to make the garment to be manufactured, the length measurement more accurately corresponds to the actual length for the garment to be manufactured.

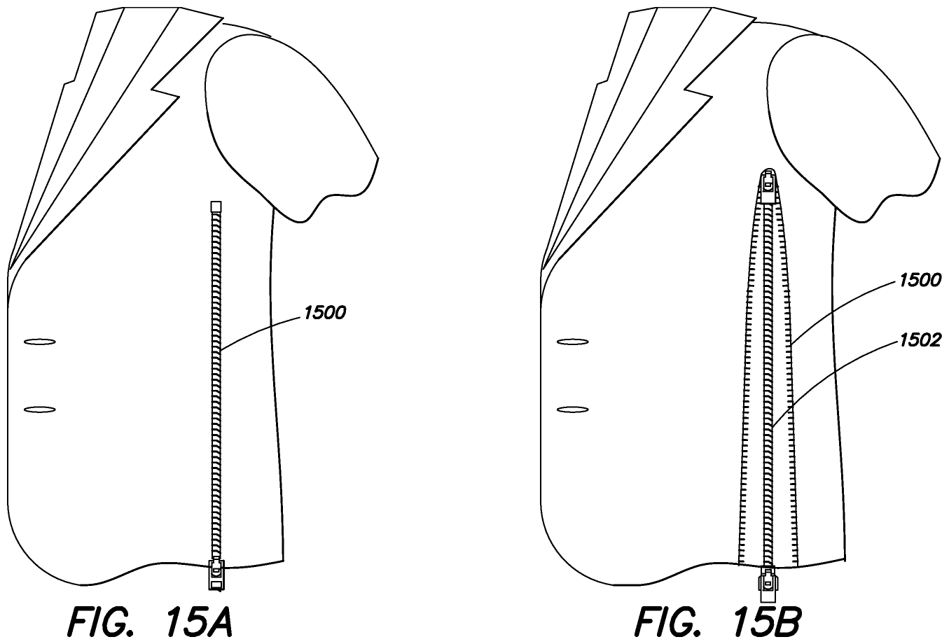

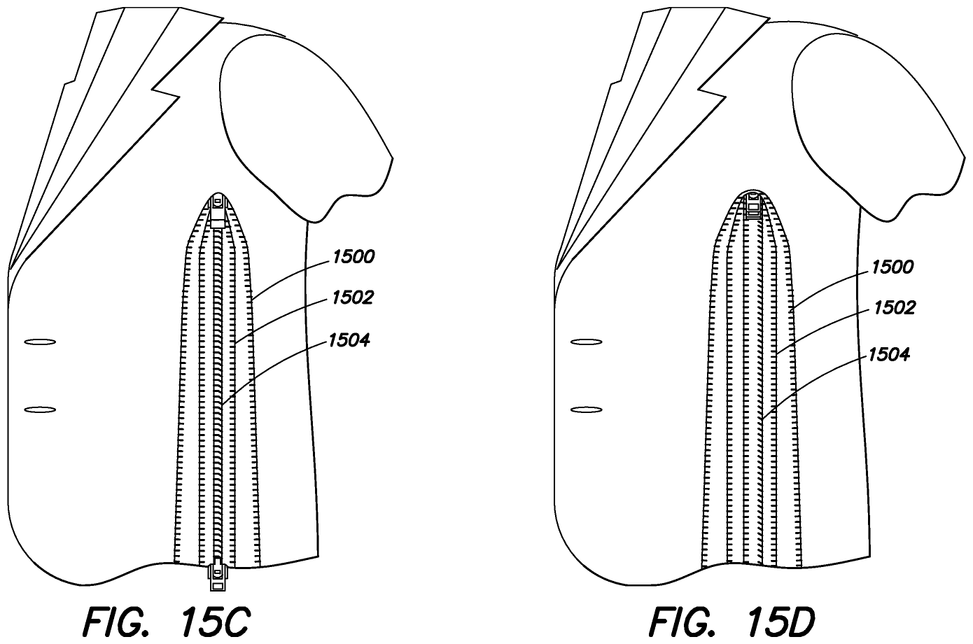

FIGS. 15A through 15D illustrate another implementation of an adjustable mechanism on one side of a blazer. Another similar adjustable mechanism typically would be provided on the other side of the blazer. In this implementation, the adjustable mechanism is in the form of three zippers 1500, 1502, and 1504. Zipper 1500 can be open (FIG. 15B) or closed (FIG. 15A). After zipper 1500 is open, zipper 1502 is revealed (FIG. 15B) and can be opened (see FIG. 15C) or remain closed (FIG. 15B). A first two pieces of material are behind zipper 1500, on either side of zipper 1502, such that when zipper 1500 is open and zipper 1502 is closed, the side of the blazer is expanded by a width of about the combined widths of the two pieces of material and the zipper 1502. Similarly, a second two pieces of material are behind zipper 1502, on either side of zipper 1504, such that when zipper 1502 is open and zipper 1504 is closed, the side of the blazer is further expanded to about a width of about the combined widths of the first two pieces of material, the second two pieces of material and the zipper 1504. A third piece of material is behind zipper 1504 when that zipper is opened (see FIG. 15D). When the zipper 1504 is open, the side of the blazer is further expanded to about a width of about the combined widths the first two pieces of material, the second two pieces of material and the third piece of material. Typically, one would adjust this mechanism in the same way on both sides of the shirt.

For the blazer with zippers, the first two pieces of material, the second two pieces of material, or the third piece of material, or any combination of these, can be wider at the waist of the garment than at the bottom of the garment. Similarly, the first two pieces of material, the second two pieces of material, or the third piece of material, or any combination of these, can be wider at the waist of the garment than at the top of the garment near the sleeve. Generally, each zipper can expand the waist of the blazer by about 2 inches on a single side.

In any of the foregoing, the zippers or other adjustment mechanisms can be color-coded to allow the user to be easily directed to a specific adjustment mechanism to use.

Garments can be designed and manufactured according to a size grid that provides custom-like fit for ready-to-wear garments, as described in U.S. Patent Publication 2014/0379515 (Hornbuckle), hereby incorporated by reference. The size grid is generated by a data mining process performed on based on data from many individuals. The data mining process identifies, groups, subgroups, and sub subgroups of anchor measures and priority measures. Such a size grid for a garment (e.g., shirt, pants) for a group of individuals, (e.g., men, women, children) includes a large number of sizes, anywhere from a few dozen to over two hundred. Patterns are generated for the garment for each size in the size grid, from which the garment in any selected size can be manufactured.

Using such a system, given dimensions of an individual at certain points of measurement, these dimensions can be screened against the groups, subgroups, and sub subgroups of anchor measures and priority measures to determine a correct size from the size grid that is close to the dimensions of the individual.

The techniques in U.S. Patent Publication 2014/0379515 can be used to define a size grid for any kind of garment for which patterns can be made. As an example, a computer system can generate a size grid for pants based on groups, subgroups, and sub subgroups of anchor measures and priority measures derived from data from many individuals. Patterns for pants can be generated, and such pants can be manufactured, according to this size grid. In such a size grid, each size specifies dimensions for a set of points of measurement for pants. Such points of measurement for pants can include, but are not limited to, for example, waist, waist top of band, hip, hip offset from bottom of fly, thigh at crotch, knee, knee at one-half of inseam, ankle, front rise to top of waistband, back rise to top of waistband, fly zipper, inseam, and waistband width. Some points of measurement are more indicative of a type of fit. In the case of pants, points of measurement related to the knee and ankle, for example, generally define fit.

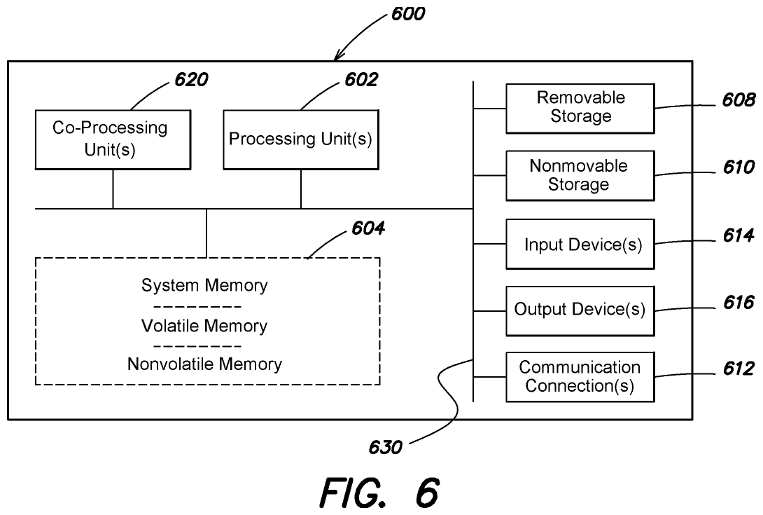

Data mining to define a size grid for a garment, and software tools to assist designers in creating patterns according to that size grid, can be implemented using a computer system such as described in connection with FIG. 6.

Given a sizing grid for a garment, which has associated points of measurement defining size, and different definitions of fit for the garment, which have associated points of measurement associated with fit, a designer generates patterns for manufacturing the garment in selected sizes in the size grid, and for different fits within those sizes.

A pattern is an object from which similar garments are manufactured. Patterns typically are made in pattern board, oak tag, plastic, cardboard, or paper, which can be traced on material for cutting, or in digital form, for use in computer-controlled manufacturing equipment, such as a laser cutter. A pattern can be first made in one form, e.g., paper, and converted to another form, e.g., digital form through a digitization process using a scanner and a computer. Using such patterns, the garment can be manufactured in any selected size and fit.

Patterns for some sizes are automatically generated from patterns of other sizes by computer based on “grading”. Grading involves moving significant points in a pattern to make a piece increase or decrease in size, in tandem with all the other pieces, to make the entire pattern larger or smaller. Most movements are defined as X-Y coordinate movements. Typically, the movements are stored in a table or other data structure, stored in memory or in a data file on a computer. The computer applies the movements to the appropriate points on a selected pattern. Grading generally reflects body dimensional change. Data describing body measurements may be based on a known standard, such as ASTM International standards, or may be proprietary. Such grading can be done using computer software run on a computer system such as shown in FIG. 6. Digital patterns can be stored in computer readable storage, transmitted over communication media among various computers and computer-controlled manufacturing equipment, and edited using software executed on computers.

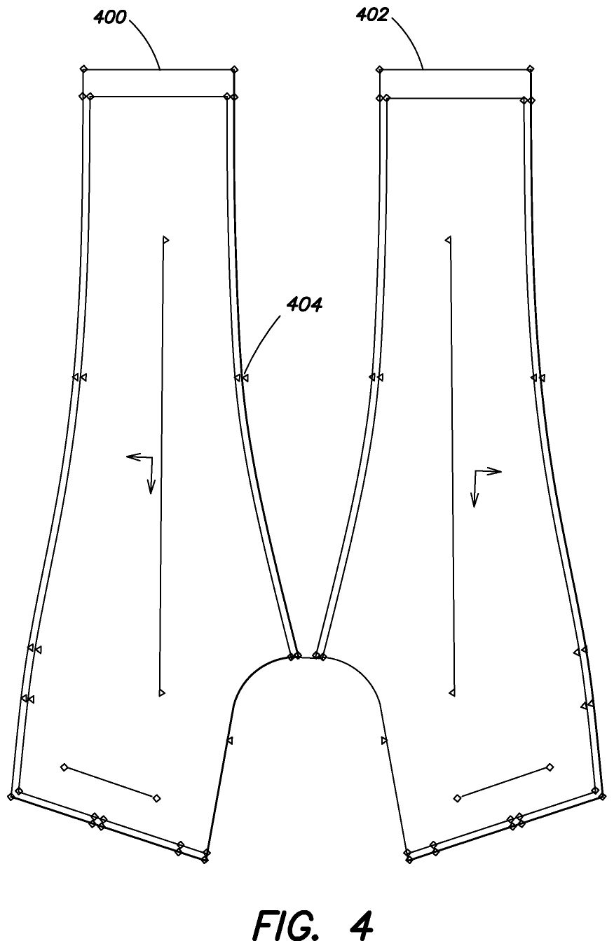

In addition to the patterns for different sizes and fits of the garment, the designer generates patterns for manufacturing sizing garments in different sizes of the size grid. FIG. 4 is an illustration of a pattern for a right back and a left back of sizing pants in a size. Generally, in FIG. 4, the right back leg panel 400 is narrower at the knee 404 than the left back leg panel 402. By way of illustration, a designer can use computer-aided drawing tools to digitize a pattern for a panel of the pants, such as the left front panel. Using the tool, a mirror image of the left front panel can be generated to create an initial right front panel. This right front panel can then be edited to modify its dimensions at selected points of measurement, such as the knee and ankle. Similar operations can be used to digitize one back panel and generate the other back panel according to another fit.

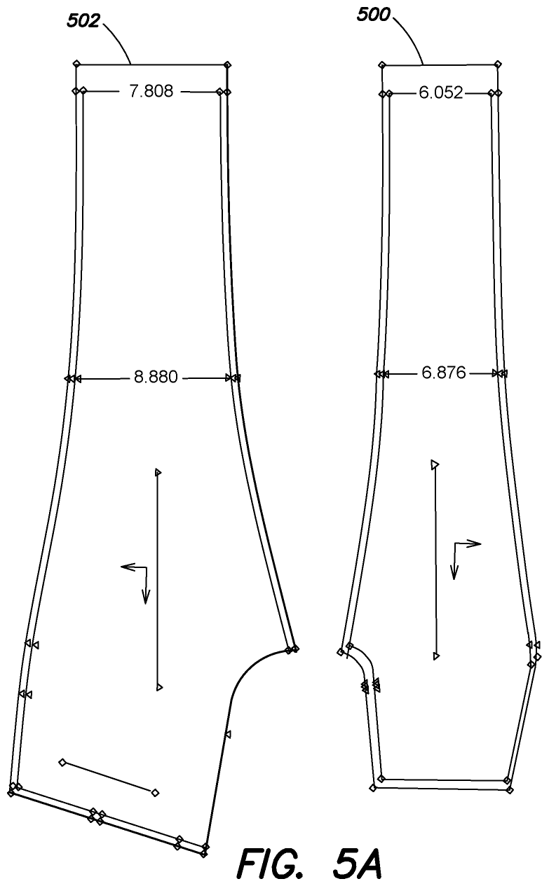

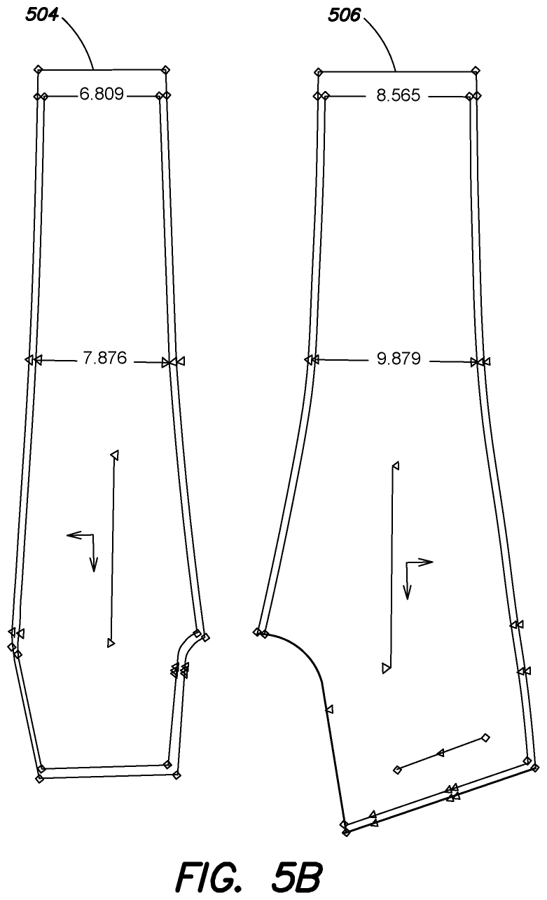

FIGS. 5A and 5B are an illustrative example of a pattern with example dimensions for sizing pants in a size. In FIG. 5A, a right front panel 500 and right back panel 502 are shown. As indicated in FIG. 5A, the dimension at the right knee point of measurement is 8.880 inches on the back panel and 6.876 inches on the front panel. The dimension at the right ankle point of measurement is 7.808 inches on the back panel and 6.052 inches on the front panel. In FIG. 5B, a left front panel 504 and left back panel 506 are shown. As indicated in FIG. 5B, the dimension at the left knee point of measurement is 9.879 inches on the back panel and 7.876 inches on the front panel. The dimension at the left ankle point of measurement is 8.565 inches on the back panel and 6.809 inches on the front panel. However, in the example panels shown in FIGS. 5A and 5B, while not illustrated to scale, the dimensions that determine the size, in this case for the hips, waist, and rise (front and back), are the same for both left and right pant legs.

Using a set of patterns for sizing garments of different sizes and fits, a set of the sizing garments of different sizes and fits can be manufactured and provided to retailers to assist customers in selecting garments before making a purchase. The set of sizing garments also can be part of a collection of garments in different sizes and fits. For each size, the set of sizing garments includes a plurality of sizing garments for that size. For example, a first sizing garment for the size has a first left part with a first dimension for a first fit in the size, and a first right part with a second dimension for a second fit in the size. A second sizing garment for the size has a second left part with the first dimension for the first fit in the size and a second right part with a third dimension for a third fit in the size. The first, second, and third fits, and respective dimensions, are different from each other.

In some implementations, sizing garments may not include different left and right sizes in different fits and may be provided in a single fit but with one or more adjustable mechanisms, or any combination of the adjustable mechanisms as described herein.

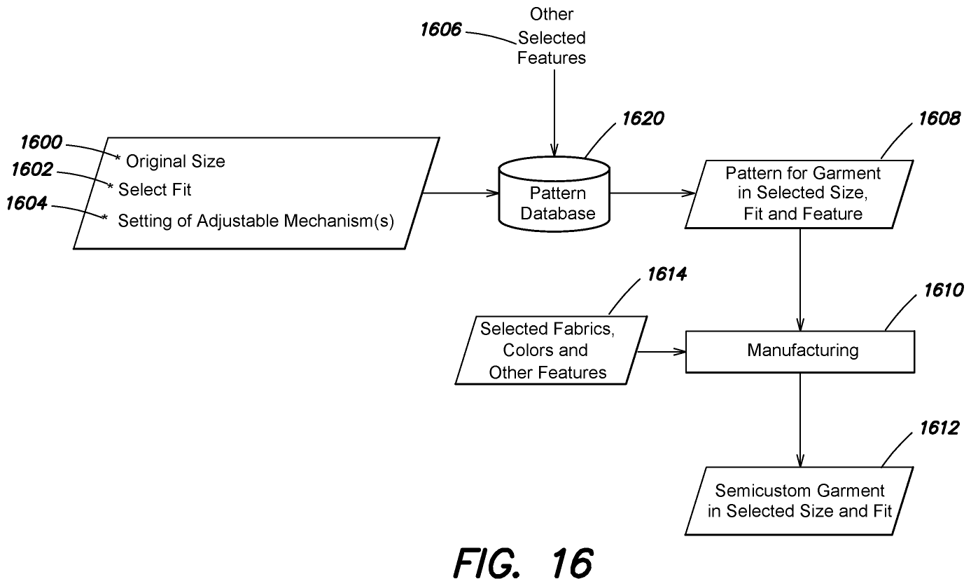

The sizing garment can be used in a method or system for manufacturing a semi-custom garment for an individual, such as shown in FIG. 16. A size 1600 for the individual is determined based on a size grid as described above. The individual is provided with a sizing garment for the size. Inputs for the individual are received, indicating a selected fit 1602 between at least a first fit and a second fit for the size, and indicating a selected position 1604 of the at least one adjustable mechanism based on the sizing garment. A pattern database 1620 is constructed that includes patterns for, in each size, each garment that corresponds to a respective possible combination of selected fits and settings of the one or more adjustable mechanisms. A pattern 1608 for the semi-custom garment for the individual is accessed from the pattern database 1620, based on the inputs indicative of the size 1600, selected fit 1602, and selected position 1604 of the at least one adjustable mechanism, and further based on any other selected features 1606 of the selected garment. The semi-custom garment 1612 for the individual is manufactured using manufacturing equipment 1610 according to the selected pattern 1608 and selected fabrics and colors 1614.

Thus, when an individual wants to purchase a garment, dimensions at selected points of measurement on the individual can be taken and mapped to a size in the size grid for that garment. Individual dimensions that can be used to select a size for pants can include, but are not limited to, for example, dimensions for waist, seat, and rise. The length (whether measured as an inseam or an outseam) of a leg can be an input individual dimension, or can be measured after mapping waist, seat, and rise dimensions to a garment size. Given dimensions at points of measurement such as the waist, seat, and rise, and a length, fit of the pants is determined in large part by dimensions at the knee and ankle. As another example, for shirts, dimensions for a shirt at points of measurement such as a wrist, upper arm, or forearm, typically affect fit of the shirt.

Software tools that map of individual measures to a size within a size grid, and any online systems used to assist customers in selecting and purchasing garments, and tools for custom-like manufacture of garments based on selected sizes and fits from customers, can be implemented using a computer system such as described in connection with FIG. 6.

Given a selected size, the individual can try on a sizing garment in that size, allowing the individual to see different fits side-by-side and make adjustments with the provided adjustable mechanisms.

After selecting a size and fit for the garment, the individual can order garments in the selected size and fit by additionally selecting fabrics, colors, and other features for the garment. In accordance the techniques in U.S. Patent Publication 2014/0379515, given digital patterns for the various sizes and fits for the garment, the selected garment can be manufactured on demand and shipped to the individual. Manufacturing garments using patterns generated according to the size grid generally is performed using automated garment manufacturing equipment, and software tools assist in designing patterns as inputs to such equipment. Such equipment and software tools are commercially available from, for example and not limited to, Gerber Technology LLC, Morgan Tecnica Spa, Lectra, Tukatech Inc., Eastman Machine Company, bullmer GmbH, EFI Optitex, and Yin USA Inc. Such manufacturing equipment generally is controlled using software executing on a computer such as in FIG. 6.

FIG. 6 is a block diagram of a general-purpose computer which processes computer program code using a processing system. Computer programs on a general-purpose computer generally include an operating system and applications. The operating system is a computer program running on the computer that manages access to various resources of the computer by the applications and the operating system. The various resources generally include memory, storage, communication interfaces, input devices and output devices.

Examples of such general-purpose computers include, but are not limited to, larger computer systems such as server computers, database computers, desktop computers, laptop and notebook computers, as well as mobile or handheld computing devices, such as a tablet computer, handheld computer, smart phone, media player, personal data assistant, audio and/or video recorder, or wearable computing device.

With reference to FIG. 6, an example computer 600 comprises a processing system including at least one processing unit 602 and a memory 604. The computer can have multiple processing units 602 and multiple devices implementing the memory 604. A processing unit 602 can include one or more processing cores (not shown) that operate independently of each other. One or more additional co-processing unit(s) 620, such as graphics processing unit 620, also can be present in the computer. The memory 604 may include volatile devices (such as dynamic random access memory (DRAM) or other random access memory device), and non-volatile devices (such as a read-only memory, flash memory, and the like) or some combination of the two, and optionally including any memory available in a processing device. Other memory such as dedicated memory or registers also can reside in a processing unit. This configuration of memory is illustrated in FIG. 6 by dashed line 604. The computer 600 may include additional storage (removable and/or non-removable) including, but not limited to, magnetically-recorded or optically-recorded disks or tape. Such additional storage is illustrated in FIG. 6 by removable storage 608 and non-removable storage 610. The various components in FIG. 6 are generally interconnected by an interconnection mechanism, such as one or more buses 630.

A computer storage medium is any medium in which data can be stored in and retrieved from addressable physical storage locations by the computer. Computer storage media includes volatile and nonvolatile memory devices, and removable and non-removable storage devices. Memory 604, removable storage 608 and non-removable storage 610 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 600 may also include communications connection(s) 612 that allow the computer to communicate with other devices over a communication medium. Communication media typically transmit computer program code, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 612 are devices, such as a network interface or radio transmitter, that interface with the communication media to transmit data over and receive data from signals propagated through communication media.

The communications connections can include one or more radio transmitters for telephonic communications over cellular telephone networks, and/or a wireless communication interface for wireless connection to a computer network. For example, a cellular connection, a Wi-Fi connection, a Bluetooth connection, and other connections may be present in the computer. Such connections support communication with other devices, such as to support voice or data communications.

The computer 600 may have various input device(s) 614 such as a various pointer devices (whether a single pointer device or a multi-pointer device or any combination thereof), such as a mouse, tablet and pen, touchpad and other touch-based input devices, stylus, image input devices, such as still and motion cameras, audio input devices, such as a microphone. The compute may have various output device(s) 616 such as a display, speakers, printers, and so on, also may be included. These devices are well known in the art and need not be discussed at length here.

The various storage 610, communication connections 612, output devices 616 and input devices 614 can be integrated within a housing of the computer, or can be connected through various input/output interface devices on the computer, in which case the reference numbers 610, 612, 614 and 616 can indicate either the interface for connection to a device or the device itself as the case may be.

An operating system of the computer typically includes computer programs, commonly called drivers, which manage access to the various storage 610, communication connections 612, output devices 616 and input devices 614. Such access generally includes managing inputs from and outputs to these devices. In the case of communication connections, the operating system also may include one or more computer programs for implementing communication protocols used to communicate information between computers and devices through the communication connections 612.

Any of the foregoing aspects may be embodied as a computer system, as any individual component of such a computer system, as a process performed by such a computer system or any individual component of such a computer system, or as an article of manufacture including computer storage in which computer program code is stored and which, when processed by the processing system(s) of one or more computers, configures the processing system(s) of the one or more computers to provide such a computer system or individual component of such a computer system.

Each component (which also may be called a “module” or “engine” or the like), of a computer system and which operates on one or more computers, can be implemented as computer program code processed by the processing system(s) of one or more computers. Computer program code includes computer-executable instructions and/or computer-interpreted instructions, such as program modules, which instructions are processed by a processing system of a computer. Generally, such instructions define routines, programs, objects, components, data structures, and so on, that, when processed by a processing system, instruct the processing system to perform operations on data or configure the processor or computer to implement various components or data structures in computer storage. A data structure is defined in a computer program and specifies how data is organized in computer storage, such as in a memory device or a storage device, so that the data can accessed, manipulated, and stored by a processing system of a computer.

It should be understood that the subject matter defined in the appended claims is not necessarily limited to the specific implementations described above. The specific implementations described above are disclosed as examples only.

What is claimed is:

1. A sizing garment, comprising:
a left part with a first dimension for a first fit in a size for a garment to be selected;
a right part with a second dimension for a second fit in the size for the garment to be selected, wherein the first fit is different from the second fit and the first dimension is substantially different from the second dimension; and
at least one adjustable mechanism along at least a third dimension of the sizing garment;
wherein the garment to be selected is based on a selection between the first fit and the second fit and a point of measurement along the third dimension based on the at least one adjustable mechanism.

2. The sizing garment of claim 1, wherein the left part has the first dimension at a first point of measurement, and the right part has the second dimension at a second point of measurement corresponding to the first point of measurement.

3. The sizing garment of claim 1, wherein the adjustable mechanism includes indicia corresponding to points of measurement along the third dimension, wherein the garment to be selected is based on a selection between the first fit and the second fit and a selected point of measurement along the third dimension.

4. The sizing garment of claim 1, wherein the adjustable mechanism comprises a mechanically adjustable part having a plurality of possible positions along the third dimension, and wherein the garment to be selected is based on a selection between the first fit and the second fit and a selected position of the mechanically adjustable part along the third dimension.

5. The sizing garment of claim 1, wherein the at least one adjustable mechanism comprises:
indicia corresponding to points of measurement along the third dimension; and
a mechanically adjustable part having a plurality of possible positions along a fourth dimension;
wherein the garment to be selected is based on a selection between the first fit and the second fit, a selected point of measurement along the third dimension, and a selected position of the mechanically adjustable part along the fourth dimension.

6. The sizing garment of claim 1, wherein the garment is a bifurcated garment.

7. The sizing garment of claim 6, wherein the garment to be selected is pants.

8. The sizing garment of claim 6, wherein the garment to be selected is a shirt.

9. The sizing garment of claim 6, wherein the garment to be selected is a jacket.

10. A set of sizing garments for selecting a garment, comprising:
a plurality of sizing garments of different sizes, wherein, for each size of a plurality of sizes, the set of sizing garments includes a respective plurality of sizing garments for the size, wherein the plurality of sizing garments for the size comprises:
a. a first sizing garment for the size, comprising:
a first left part with a first dimension for a first fit in the size for the garment to be selected, and
a first right part with a second dimension for a second fit in the size for the garment to be selected, wherein the first fit is different from the second fit and the first dimension is substantially different from the second dimension; and
b. a second sizing garment for the size, comprising:
a second left part with the first dimension for the first fit in the size for the garment to be selected; and
a second right part with a third dimension for a third fit in the size for the garment to be selected, wherein the first fit is different from the third fit and the first dimension is substantially different from the third dimension, and the second fit is different from the third fit and the second dimension is substantially different from the third dimension.

11. The set of sizing garments of claim 10, wherein the first left part has the first dimension at a first point of measurement, and the first right part has the second dimension at a second point of measurement corresponding to the first point of measurement.

12. The set of sizing garments of claim 10, wherein the adjustable mechanism includes indicia corresponding to points of measurement along the third dimension, wherein the garment to be selected is based on a selection between the first fit and the second fit and a selected point of measurement along the third dimension.

13. The set of sizing garments of claim 10, wherein the adjustable mechanism comprises a mechanically adjustable part having a plurality of possible positions along the third dimension, and wherein the garment to be selected is based on a selection between the first fit and the second fit and a selected position of the mechanically adjustable part along the third dimension.

14. The set of sizing garments of claim 10, wherein the at least one adjustable mechanism comprises:
indicia corresponding to points of measurement along the third dimension; and
a mechanically adjustable part having a plurality of possible positions along a fourth dimension;
wherein the garment to be selected is based on a selection between the first fit and the second fit, a selected point of measurement along the third dimension, and a selected position of the mechanically adjustable part along the fourth dimension.

15. The set of sizing garments of claim 10, wherein the garment to be selected is a bifurcated garment.

16. The set of sizing garments of claim 15, wherein the garment to be selected is pants.

17. The set of sizing garments of claim 15, wherein the garment to be selected is a shirt.

18. The set of sizing garments of claim 15, wherein the garment to be selected is a jacket.

19. A method of manufacturing a semi-custom garment for an individual, comprising:
determining a size for the individual from a size grid;
providing a sizing garment for the size, the sizing garment comprising at least one adjustable mechanism having a plurality of selectable positions along at least a third dimension of the sizing garment;
receiving, for the individual, inputs based on a selected fit between a first fit and a second fit for the size and a selected position of the at least one adjustable mechanism;
accessing a pattern for the semi-custom garment based on the inputs indicative of the size for the individual, the selected fit, and the selected position of the at least one adjustable mechanism; and
manufacturing the semi-custom garment according to the accessed pattern.

20. The method of claim 19 wherein the sizing garment comprises a left part with a first dimension for the first fit in a size for a garment to be selected, a right part with a second dimension for the second fit in the size for the garment to be selected, wherein the first fit is different from the second fit and the first dimension is substantially different from the second dimension.
